(19) United States
(12) Patent Application Publication
(10) Pub. No.: US 2005/0173688 A1
(43) Pub. Date: Aug. 11, 2005

(54) Pulley Block

(76) Inventor: Giles Smith, Burnham-on-Crouch (GB)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/051,022

(22) Filed: Feb. 4, 2005

(30) Foreign Application Priority Data
Feb. 5, 2004 (GB) 04 02554.0

(51) Int. Cl. B66D 3/04

(52) U.S. Cl. 254/405

(57) ABSTRACT

A pulley block has a body defined by a pair of opposed cheeks and a bridging portion holding the cheeks spaced apart, a sheave being rotatably mounted between the cheeks. A generally U-shaped strap has a base section extending over the bridging portion and a pair of arms which overlie the respective external surface of the cheeks. The end portion of each arm remote from the base section is enlarged and the external surface of each cheek is formed with a recess in which the enlarged end portion is received so that loads may be transferred between the block body and the strap by the interengagement of the enlarged end portions and recesses.

### BACKGROUND OF THE INVENTION

a) Field of the Invention

This invention relates to a pulley block and in particular to a pulley block having a body defining a pair of opposed cheeks and a sheave rotatably mounted therebetween.

Though the pulley block of this invention may be used in a variety of circumstances, it has a particular application in relation to racing dinghies. As such, it will be described exclusively with reference to that use, even though the invention is not to be regarded as limited thereto.

b) Description of the Prior Art

Pulley blocks are used extensively on the running rigging of racing dinghies, to assist in the hoisting and trimming of the sails, as well as for other lines used on dinghies. Such pulley blocks are required to have very low friction in order to minimise losses and also to have relatively low weights. Further, pulley blocks used on racing dinghies are frequently highly stressed and so must display great strength in order not to fail at inconvenient times.

A common form of pulley block has a body defining a pair of opposed cheeks between which is rotatably mounted a sheave, the cheeks being held apart at the required spacing by a bridging member. A generally U-shaped metallic strap having a base section from which extends a pair of arms is fitted to the body so that the arms overlie the external surface of a respective cheek, the base section of the strap extending over the bridging member. The strap is usually secured to the body by means of through-fasteners, one of which serves as a shaft on which the sheave is mounted by suitable bearings. The part of the strap extending over the bridging member is adapted for direct or indirect connection to some other component with which the block is to be associated, such that the load imparted to the sheave by a line is transferred through the shaft to the strap, and then to that other component.

Recently, blocks have been introduced which have an annular sheave supported by races defined between the outwardly-directed faces of the sheave and the inwardly-directed faces of the cheeks. As such, there is no need to provide a shaft for rotationally mounting the sheave, so that the load is transferred indirectly from the sheave to the strap, through the cheeks. As a consequence, it has been possible to shorten the length of the arms of the strap, but the attachment of the strap to the cheeks must be enhanced, by providing a multiplicity of fasteners. Such fasteners may extend through the end regions of the arms of the strap, adjacent but within the inner periphery of the sheave. The extra fasteners may increase the weight of the pulley block and will also add to the manufacturing cost. Further, to prevent the reliability of the block being compromised by virtue of the load imparted to the sheave by a line extending therearound being transferred indirectly through the cheeks to the strap, it is necessary to ensure there are sufficient fasteners for the strap.

### BRIEF SUMMARY OF THE INVENTION

The present invention aims at addressing the above problem, of reducing the weight of the block without reducing the strength, so as to be comparable to a conventional arrangement having a pulley rotatably mounted on a shaft which is directly connected to the arms of the strap.

According to the present invention there is provided a pulley block having a body defined by a pair of opposed cheeks and a bridging portion holding the opposed cheeks in a spaced apart disposition. A sheave is rotatably mounted between the cheeks and a generally U-shaped strap having a base section and a pair of arms extending therefrom is arranged so that the base section extends over the bridging portion and each arm overlies the external surface of a respective one of the pair of opposed cheeks. Each arm has an end portion remote from the base section of the strap which end portion is enlarged and the external surface of each cheek is formed with a recess in which is received the respective enlarged end portion, whereby loads may be transferred between the block body and the strap by the interengagement of enlarged end portion and recess.

### BRIEF DESCRIPTION OF THE DRAWINGS

The drawings show one specific embodiment of pulley block constructed and arranged in accordance with this invention, though solely by way of example. In the drawings:

FIG. 1 is an isometric view of part of the embodiment of pulley block, from the outside and showing only one side cheek and a mounting pin, the sheave, the other side cheek and a connecting strap all having been removed for clarity;

FIG. 2 is a partial rear view, with parts cut away, to show the mounting of the sheave on the side cheek;

FIG. 3 is an isometric view of a connecting strap for use with a block having two side cheeks as shown in FIG. 1; and

FIG. 4 is a diagrammatic isometric section through the assembled block.

### DETAILED DESCRIPTION OF THE INVENTION

Though the pulley block of this invention could be used with a conventional block having a shaft-mounted sheave, it particularly lends itself to a block having an annular sheave mounted directly to the inwardly-facing surfaces of the cheeks, rather than on bearings carried on a shaft extending through the cheeks. For such an arrangement, the arms may be made significantly shorter than otherwise would be the case, so saving weight. A single fastener may extend through holes formed in the enlarged end portions of the strap and through the cheeks, adjacent the internal periphery of the sheave, but within the space defined thereby. In this way, significant gains in weight saving may be achieved, without compromising strength and reliability. The U-shaped strap should have a relatively high strength as compared to the material of the block. Typically, the strap will be metallic and preferably of a corrosion-resistant metal such as stainless steel.

Preferably, each said end portion is enlarged in the transverse direction with respect to the length of the arm. Such enlargement may be essentially symmetrical with respect to the length of the arm. In this case, the thickness of the arm in the region of the enlarged portion may be substantially the same as the thickness of the arm remote from the end portion.

Advantageously, the depth of the recess which accommodates the enlarged end portion of the arm is substantially the same as the thickness of the enlarged end portion, such that the outwardly-directed face of each arm is substantially flush with the adjacent outer surface of the respective cheek. Further, each cheek may be provided with a slot leading into said recess, whereby the respective arm of the U-shaped strap may be accommodated in that slot.

In a preferred form of the invention, the enlarged end portion of each arm of the strap is of a generally arcuate shape, centred on the rotational axis of the sheave. The enlarged end portion may taper away from the axis of the respective arm, so achieving further reductions in weight. Preferably, the edge of the enlarged end portion of the arm extends substantially perpendicularly to the plane containing the arm, the walls of the cheek defining the recess in which the enlarged end portion is received being a close fit to those edges of the enlarged end portion in order to optimise the transfer of loads between the block body and the strap.

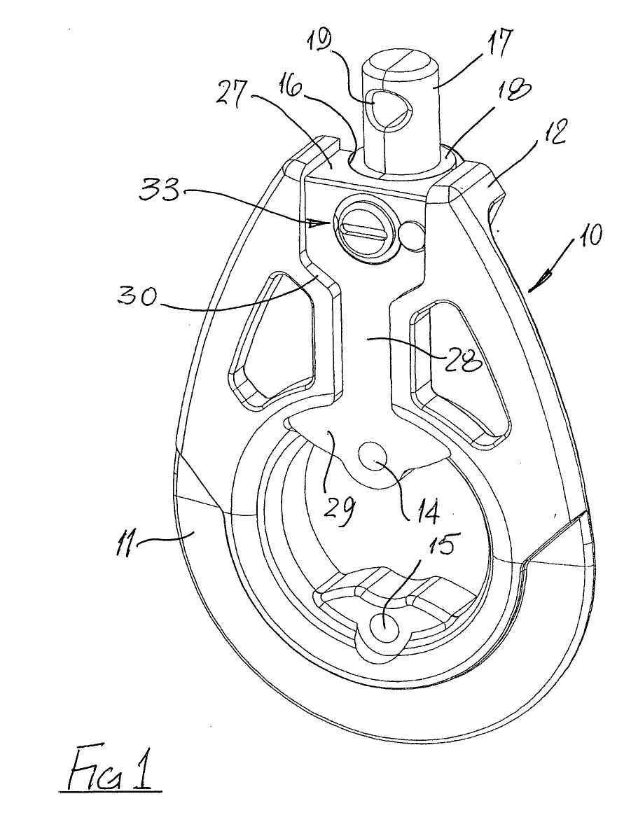

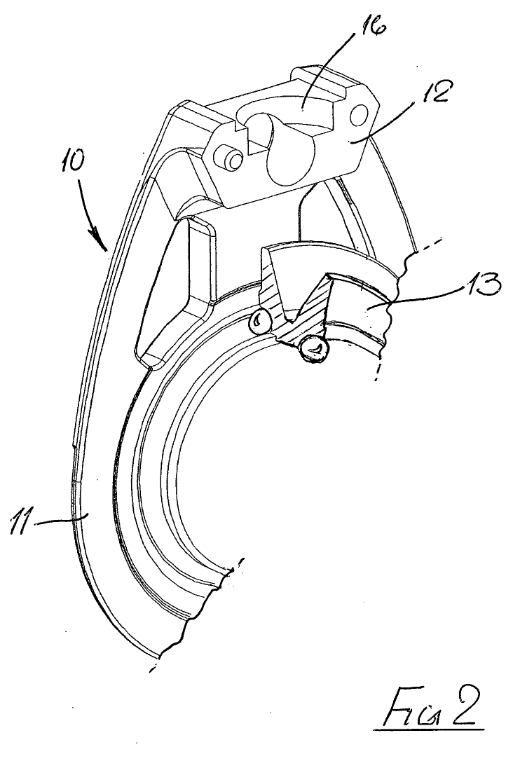

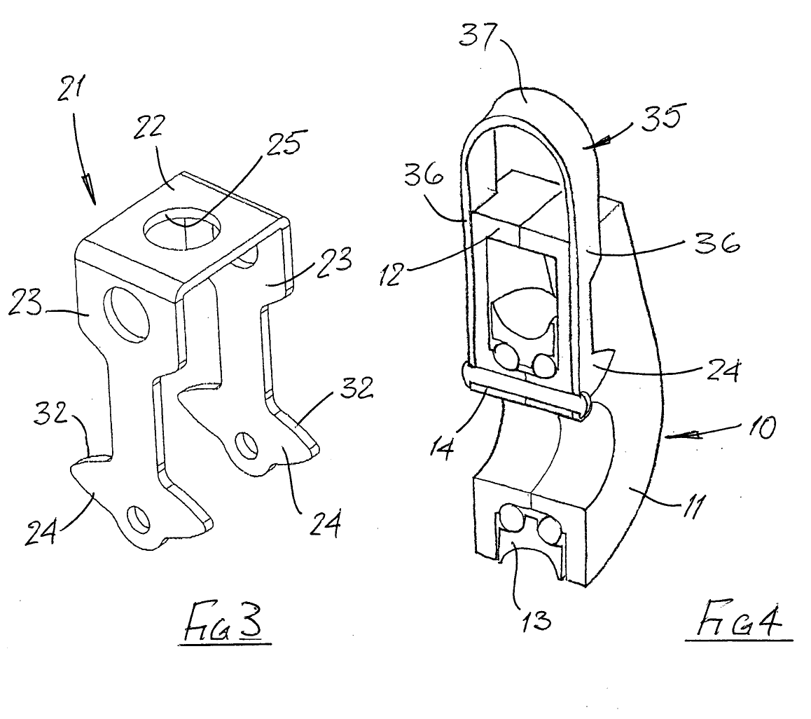

The accompanying drawings show an embodiment of pulley block of this invention. This block has a pair of moulded plastics body parts 10 only one of which is shown in FIGS. 1 and 2. Each body part defines a side cheek 11 and includes half of a bridging member 12 such that when the two body parts are fitted together, the bridging member is completed and serves to hold the two side cheeks 11 parallel and spaced apart by a distance sufficient to accommodate an annular rotatable sheave 13 (FIG. 4) therebetween. The assembly of the two body parts 10 is held together by a metallic strap (FIG. 3, to be described below) and two bolts (not shown) or similar retaining fasteners extending through aligned holes 14,15 in the two body parts and which will lie within the bore of the annular sheave 13 of the completed block, the bolt which passes through hole 14 also passing through the metallic strap. For smaller blocks, it may not be necessary to provide two fasteners nor hole 15, as shown for example in FIG. 4.

The bridging member halves, when assembled to form the complete bridging member, define a bore 16 extending at right-angles to the axis of rotation of a mounted sheave. A mounting pin 17 has an enlarged head 18 which is accommodated in the bore 16, for free rotation with respect thereto. As shown in the drawings, the mounting pin has a transverse hole 19 externally of the block body, whereby the block may be attached to some other component by means of a shackle (not shown), the shackle pin extending through the hole 19 of the block mounting pin 17.

The pin 17 is retained in bore 16 by means of the U-shaped metallic strap 21 (FIG. 3) having a base section 22 from which extend two arms 23 substantially at right-angles to the base section. At its free end, each arm 23 has an enlarged portion 24, extending arcuately in the plane of the arm and symmetrically with respect to the length of the arm. Each enlarged portion 24 tapers in the arcuate direction away from the arm, and has a hole which registers with hole 14 of the body parts, when the strap is fitted thereto. The base section 22 has a central hole 25 through which the pin 17 passes, the diameter of the hole 25 being smaller than that of the enlarged head 18 of the pin. In this way, on completion of the block, loads are transferred by the strap from the body parts 10 to the pin 17.

Each body part 10 is provided with a groove dimensioned to accommodate the U-shaped strap 21, such that the external surface of the strap is essentially flush with the outer surface of the block body. The bridging member 12 includes a groove part 27 within which the base section 22 of the strap 21 extends, whereby the head 18 of the pin 17 may bear directly on the strap. Further, each cheek has a further groove part 28 to accommodate the respective arm 23 of the strap, that further groove part extending to the hole 14 and defining a recess 29 to accommodate the enlarged portion 24 of the strap. As shown in the drawings, the side walls 30 of the groove and recess extend essentially at right-angles to the major area of the groove; similarly, the side walls 32 of the strap 21 also extend at right-angles to the plane of the strap arms, whereby a close interfit may be achieved between the strap and the body parts defining the groove parts 28 and recess 29.

Also shown in FIG. 1 is a locking mechanism 33 which selectively may lock the pin 17 against rotation but this mechanism forms no part of the present invention and will not be described in further detail here.

FIG. 4 shows an alternative embodiment of block utilising the same principles of the present invention, as does the embodiment of FIGS. 1 to 3 above. Like reference numbers are used to indicate like components and these will not be described in further detail here. However, the embodiment of FIG. 4 differs in that no mounting pin 17 is provided; rather, the strap 35 has lengthened side arms 36 and the base section 37 of the strap is spaced from the bridging member 12. That base section is generally rounded to permit the direct connection of the block to some other component for example by means of a shackle the pin of which passes through the space between the bridging member 12 and the base section 37 of the strap 35. In all other material respects, the block of FIG. 4 corresponds to that of FIGS. 1 to 3.

With the embodiments of block of this invention, only a single fastener is used to hold the strap 21 (or 35) to the block. However, by virtue of the enlarged portion 24 of each arm of the strap closely fitting within the recess 29, loads between the side cheeks 11 of the block body may be transferred to the strap without the need to provide a plurality of separate fasteners extending through the strap. In this way, it is possible to provide adequate strength for the intended use of the block, without compromising reliability and at the same time to achieve a significant weight reduction.

1. A pulley block having a body defined by a pair of opposed cheeks each having an external surface and a bridging portion holding the opposed cheeks in a spaced apart disposition, said block further comprising a sheave rotatably mounted between the cheeks, and a generally U-shaped strap having a base section and a pair of arms extending from the base section, the U-shaped strap having the base section thereof extending over the bridging portion and each arm thereof overlying the external surface of a respective one of said pair of opposed cheeks, in which block each arm has an end portion remote from the base section of the strap which said end portion is enlarged and the external surface of each said cheek is formed with a recess in which is received the respective enlarged end portion, whereby loads may be transferred between the block body and the strap by the interengagement of said enlarged end portions and said recesses.

2. A pulley block as claimed in claim 1, wherein the each said end portion is enlarged in a direction transverse to the length of the arm from the base section to the end portion.

3. A pulley block as claimed in claim 2, wherein each said end portion is enlarged in the transverse direction essentially symmetrically with respect to the length of the arm.

4. A pulley block as claimed in claim 2, wherein the thickness of the arm in the region of said enlarged end portion is substantially the same as the thickness of the arm remote from the end portion.

5. A pulley block as claimed in claim 1, wherein the depth of said recess in which is received the enlarged end portion of the arm is substantially the same as the thickness of the enlarged end portion.

6. A pulley block as claimed in claim 1, wherein the edges of said enlarged end portion of each arm extends substantially perpendicularly to a plane containing the arm, the walls of the cheek defining the recess being a close fit to said edges of the enlarged end portion.

7. A pulley block as claimed in claim 1, wherein said enlarged end portion on one arm is similarly-formed and aligned with said enlarged end portion on the other arm

8. A pulley block as claimed in claim 1, wherein each said cheek is provided with a slot leading into said recess, the respective arm being accommodated in said slot.

9. A pulley block as claimed in claim 1, wherein said body comprises two similar parts each defining a cheek of the block and a portion of the bridging member, holes are formed in the enlarged end portions of the strap, and there is provided a fastener extending between the two block parts to hold the parts together said fastener extending through said holes.

10. A pulley block as claimed in claim 9, wherein said fastener comprises a rivet extending through aligned bores in the block parts and also through said holes in the enlarged end portions.

11. A pulley block as claimed in claim 1, wherein each enlarged end portion is of arcuate form, centred on the rotational axis of the sheave.

12. A pulley block as claimed in claim 1, wherein the U-shaped strap is of a metal.

13. A pulley block as claimed in claim 1, wherein the sheave is in the form of an annulus.

14. A pulley block as claimed in claim 13, wherein the block body defines a pair of spaced races and the sheave is provided with a pair of corresponding races, balls being provided between the opposed races on the body and sheave respectively whereby the sheave is rotatably supported on the body.

15. A pulley block having a body defined by a pair of opposed cheeks each having an external surface and a bridging portion holding the opposed cheeks in a spaced apart disposition, said block further comprising a sheave rotatably mounted between the cheeks, and a generally U-shaped strap having a base section and a pair of arms extending from the base section, the U-shaped strap having the base section thereof extending over the bridging portion and each arm thereof overlying the external surface of a respective one of said pair of opposed cheeks, in which block each arm has an end portion remote from the base section of the strap which said end portion is enlarged and the external surface of each said cheek is formed with a recess in which is received the respective enlarged end portion, and in which block a slot is formed in each side cheek leading from the bridging portion to said recess, the respective arm being accommodated in said slot, and wherein the edges of said enlarged end portion of each arm extend substantially perpendicularly to a plane containing the arm, the walls of the cheek defining the recess being a close fit to said edges of the enlarged end portion, each arm having holes formed in the enlarged end portions of the strap, and a fastener extending through said holes between the two block parts to hold the parts together, whereby loads may be transferred between the block body and the strap by the interengagement of said enlarged end portions and said recesses.

16. A pulley block as claimed in claim 15, wherein the block parts have aligned bores and said fastener comprises a rivet, said rivet extending through the aligned bores and also through said holes in the enlarged end portions.

17. A pulley block as claimed in claim 16, wherein the block body defines a pair of spaced races and the sheave is provided with a pair of corresponding races, balls being provided between the opposed races on the body and sheave respectively whereby the sheave is rotatably supported on the body.
